(19) United States
(12) Patent Application Publication
(10) Pub. No.: US 2026/0228780 A1
(43) Pub. Date: Aug. 6, 2026

(54) VIRTUAL SPACE INFORMATION MANAGEMENT METHOD AND VIRTUAL SPACE INFORMATION MANAGEMENT SYSTEM

(71) Applicant: Hitachi, Ltd., Tokyo (JP)

(72) Inventor: Masao YAMASHIRO, Tokyo (JP)

(21) Appl. No.: 19/143,682

(22) PCT Filed: Feb. 7, 2024
(86) PCT No.: PCT/JP2024/004037

§ 371 Date: Jun. 26, 2025

(30) Foreign Application Priority Data
Mar. 24, 2023 (JP) 2023-048604

(51) Int. Cl. G06Q 30/0273; G06T 11/00

(52) U.S. Cl. CPC G06Q 30/0273; G06T 11/00

(57) ABSTRACT

A virtual space information management method, including: a procedure of holding virtual space configuration information indicating a configuration of a virtual space, and when receiving an input of information on setting a partial space in the virtual space, holding the information on setting the partial space as area setting information; a procedure of, when receiving an input of information on a policy executed in the partial space, holding the information on the policy as policy information; a procedure of generating information to be output to a user of the virtual space and holding the information as policy display pattern information based on the policy in the partial space; and a procedure of evaluating the policy based on an action of the user of the virtual space in the virtual space.

### CLAIM OF PRIORITY

The present application claims the priority of Japanese Patent Application No. 2023-048604, filed on Mar. 24, 2023, the entire contents of which are incorporated herein by reference.

### TECHNICAL FIELD

The present invention relates to a technique for managing an area in a virtual space.

### BACKGROUND ART

As a technique for implementing and evaluating policies on the Internet, for example, there is a technique described in JP2022-83998A (PTL 1). PTL 1 discloses that “a content arrangement method includes a stage of providing a queue card list that is a dedicated customer object in a card form for content arrangement, and a stage of arranging a content set in units of cards using a queue card selected from the queue card list”.

### CITATION LIST

### Patent Literature

PTL 1: JP2022-83998A

### SUMMARY OF INVENTION

### Technical Problem

For example, as described in PTL 1, there is known a technique of implementing policies such as a so-called AB test on the Internet and evaluating a result thereof. However, a mechanism of opening an area in a virtual space, receiving an input of a policy to the area, and managing, implementing, and evaluating the input policy has not been known in the related art.

### Solution to Problem

To solve at least one of the above problems, a typical example of the invention disclosed in the present application is a virtual space information management method executable by a computer system, the computer system including a control device that executes predetermined processing and a storage device accessible by the control device, the storage device holding virtual space configuration information indicating a configuration of a virtual space, the virtual space information management method including: an area setting procedure of, by the control device, when receiving an input of information on setting a partial space in the virtual space, storing the information on setting the partial space in the storage device as area setting information; an input policy management procedure Of, by the control device, when receiving an input of information on a policy executed in the partial space, storing the information on the policy in the storage device as policy information; an output information management procedure of, by the control device, generating information to be output to a user of the virtual space and holding the information in the storage device as policy display pattern information based on the policy in the partial space; and a policy evaluation procedure of, by the control device, evaluating the policy based on an action of the user of the virtual space in the virtual space.

### Advantageous Effects of Invention

According to an aspect of the invention, it is possible to achieve efficient and highly accurate policy evaluation by appropriately managing the policies executed in the virtual space. Problems, configurations, and effects other than those described above will be clarified by the description of the following embodiment.

### BRIEF DESCRIPTION OF DRAWINGS

FIG. 1 is a diagram illustrating a virtual space to be managed by a virtual space information management system according to an embodiment of the invention and users thereof.

FIG. 2 is a block diagram illustrating a configuration of the virtual space information management system according to the embodiment of the invention.

FIG. 3 is a flowchart illustrating processing executed by an open area setting unit of the virtual space information management system according to the embodiment of the invention.

FIG. 4 is a diagram illustrating open area setting information held by the virtual space information management system according to the embodiment of the invention.

FIG. 5 is a diagram illustrating open areas of various types set by the virtual space information management system according to the embodiment of the invention.

FIG. 6 is a flowchart illustrating processing executed by an input policy management unit of the virtual space information management system according to the embodiment of the invention.

FIG. 7 is a diagram illustrating policy information held by the virtual space information management system according to the embodiment of the invention.

FIG. 8 is a flowchart illustrating processing executed by a display information management unit of the virtual space information management system according to the embodiment of the invention.

FIG. 9 is a diagram illustrating generation of a display pattern by the display information management unit of the virtual space information management system according to the embodiment of the invention.

FIG. 10 is a diagram illustrating a policy display pattern held by the virtual space information management system according to the embodiment of the invention.

FIG. 11 is a flowchart illustrating processing executed by a policy evaluation unit of the virtual space information management system according to the embodiment of the invention. FIG. 12 is a diagram illustrating an action log of virtual space utilization users held by the virtual space information management system and policy determination results according to the embodiment of the invention.

FIG. 13 is a diagram illustrating evaluation results of input policies held by the virtual space information management system according to the embodiment of the invention.

FIG. 14 is a diagram illustrating an open area setting screen output by the virtual space information management system according to the embodiment of the invention.

FIG. 15 is a diagram illustrating an input policy management screen output by the virtual space information management system according to the embodiment of the invention.

FIG. 16 is a diagram illustrating a policy evaluation screen output by the virtual space information management system according to the embodiment of the invention.

### DESCRIPTION OF EMBODIMENTS

Hereinafter, an embodiment of the invention will be described with reference to the drawings.

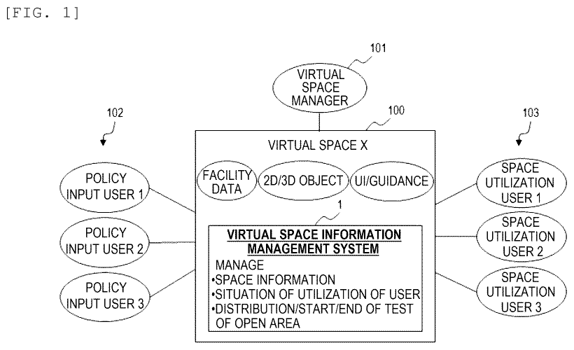

FIG. 1 is a diagram illustrating a virtual space to be managed by a virtual space information management system according to the embodiment of the invention and users thereof.

A virtual space 100 provided in the present embodiment is a three-dimensional virtual space such as a space called a metaverse. Data on facilities such as buildings and rooms in the buildings in the virtual space 100, data on two-dimensional or three-dimensional objects arranged in the virtual space 100, and data such as a user interface (UI) and guidance provided to users of the virtual space 100 are managed by a virtual space manager 101 through a virtual space information management system 1.

Two types of users, a policy input user 102 and a space utilization user 103, are assumed as the users of the virtual space 100 of the present embodiment. The space utilization user 103 is a general user who performs activities in the virtual space 100, and may perform various activities in the virtual space 100 using, for example, his or her own incarnation (avatar). In this case, the space utilization user 103 may be able to see a picture of the virtual space 100 from a visual point of the avatar, for example. In the following description, the visual point of the avatar in the virtual space 100 may be described as a visual point of the user.

The activities performed by the space utilization user 103 in the virtual space 100 can be any activities and are not limited to a specific one, and for example, the activities may be merely passing while viewing a landscape or an event in the virtual space 100, may be purchasing a product or a service sold in a store or the like in the virtual space 100, or may be interacting with another space utilization user 103 in the virtual space 100.

In the present embodiment, the virtual space manager 101 can open a specific partial area of the virtual space 100 to a person other than the virtual space manager 101. Hereinafter, the open partial area is also referred to as an open area. The policy input user 102 is a user who takes various policies using the open area. The policy to be taken is not limited to a specific one, and is, for example, a policy in which a product, an advertisement, or the like is disposed in the open area and a reaction of the space utilization user thereto is tested. For example, a so-called AB test may be performed in which products or the like having different designs are arranged and reactions thereto are compared.

The virtual space information management system 1 according to the present embodiment manages space information of the open area, a situation of utilization by users, distribution/start/end of the test, and the like.

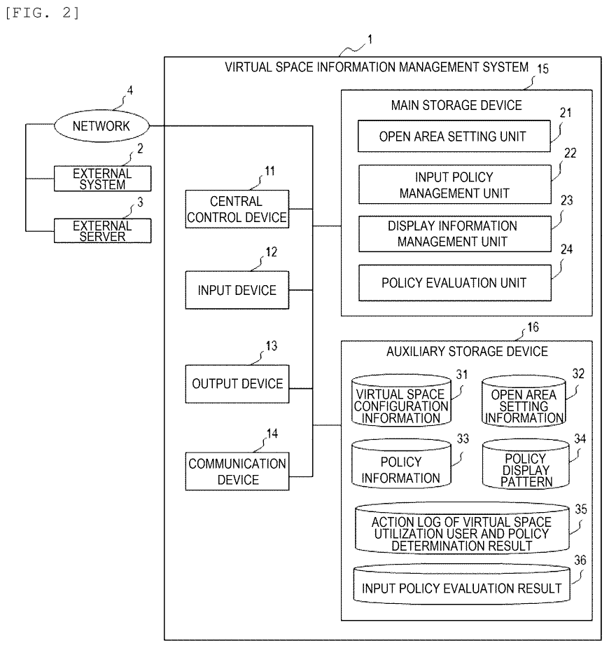

FIG. 2 is a block diagram illustrating a configuration of the virtual space information management system 1 according to the embodiment of the invention.

The virtual space information management system 1 of the present embodiment includes a central control device 11, an input device 12, an output device 13, a communication device 14, a main storage device 15, and an auxiliary storage device 16. These devices are connected to each other via a bus.

The main storage device 15 and the auxiliary storage device 16 store programs and data used by the central control device 11. The main storage device 15 is implemented by, for example, a semiconductor memory, and is mainly used to hold programs and data currently being executed. The central control device 11 executes various processing according to programs stored in the main storage device 15. When the central control device 11 operates according to the programs, functional units such as an open area setting unit 21, an input policy management unit 22, a display information management unit 23, and a policy evaluation unit 24 are implemented.

The auxiliary storage device 16 is implemented by, for example, a large-capacity storage device such as a hard disk drive or a solid state drive, and is used to hold programs and data for a long period of time. The auxiliary storage device 16 holds, for example, virtual space configuration information 31, open area setting information 32, policy information 33, a policy display pattern 34, an action log of the virtual space utilization user, a policy determination result 35, and an input policy evaluation result 36. These information will be described in detail below.

The central control device 11 may be implemented by a single processing unit or a plurality of processing units, and may include a single or a plurality of calculation units or a plurality of processing cores. The central control device 11 may be implemented as one or more central processing units, a microprocessor, a microcomputer, a microcontroller, a digital signal processor, a state machine, a logic circuit, a graphics processing unit, a chip-on-system, and/or any device that operates a signal based on a control instruction.

The programs and data stored in the auxiliary storage device 16 are loaded into the main storage device 15 during activation or when necessary, and the central control device 11 executes the programs to execute processing of each functional unit of the virtual space information management system 1. Therefore, in the following description, the processing executed by each functional unit of the metaverse space information management system 1 is the processing executed by the central control device 11 according to the programs.

The input device 12 is a hardware device for a user to input instructions, information, and the like to the virtual space information management system 1. The output device 13 is a hardware device that presents various images for input and output, and is for example, a display device or a printing device. The communication device 14 is an interface for connection to a network 4.

The virtual space information management system 1 may be connected to an external system 2 and an external server 3 via the network 4. For example, at least a part of the information held in the auxiliary storage device 16 may be acquired from either the external system 2 or the external server 3.

Note that the virtual space information management system 1 may include two or more central control devices 11. The functions of the virtual space information management system 1 can also be implemented in a plurality of computers. In this case, the plurality of computers communicate with each other via a network. For example, a part of the plurality of functions of the virtual space information management system 1 may be implemented in one computer, and other parts may be implemented in other computers.

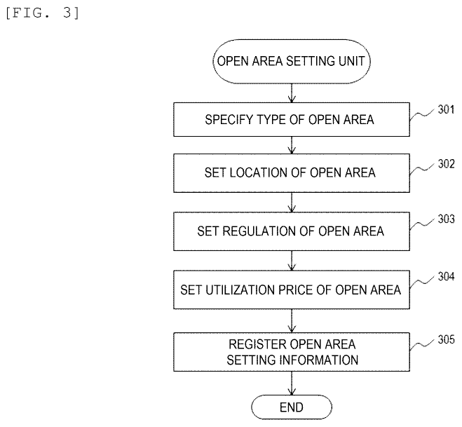

FIG. 3 is a flowchart illustrating processing executed by the open area setting unit 21 Of the virtual space information management system 1 according to the embodiment of the invention.

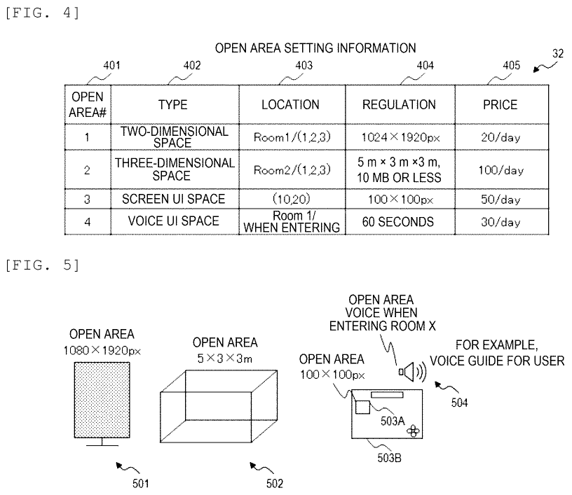

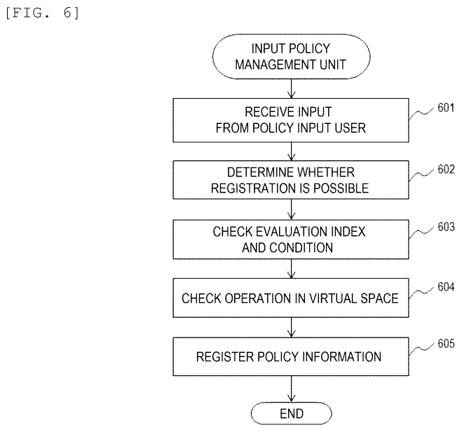

The open area setting unit 21 sets a type, a location, a regulation, and a utilization price of the open area (steps 301, 302, 303, and 304, respectively), and registers the set information of the open area as the open area setting information 32. Details of the setting information will be described below with reference to FIGS. 4 and 5.

FIG. 4 is a diagram illustrating the open area setting information 32 held by the virtual space information management system 1 according to the embodiment of the invention.

The open area setting information 32 includes an open area number 401, a type 402, a location 403, a regulation 404, and a price 405.

The open area number 401 is a number for uniquely identifying each open area.

The type 402 is information indicating the type of each open area, and is set in step 301 in FIG. 3. Examples of the type of the open area include a two-dimensional space in the virtual space 100, a three-dimensional space in the virtual space 100, a UI display space on a screen that displays a picture of the virtual space 100 to the space utilization user 103, and a UI space in voice provided together with the picture of the virtual space 100.

The location 403 is information indicating the location where each open area is set, and is set in step 302 in FIG. 3. For example, when the open area is a two-dimensional or three-dimensional space, a coordinate value indicating a position of the space may be set as the location 403. When the open area is a space in the UI screen, a coordinate value indicating the position of the open area in the UI screen may be set as the location 403. When the open area is a UI space in voice, a position where the voice is output (for example, a voice output timing with respect to a predetermined reference) may be set as the location 403.

The regulation 404 is information indicating a range of the open area, and is set in step 303 in FIG. 3. For example, when the open area is a two-dimensional space, a three-dimensional space, or a UI space, a pixel number to be displayed, a data amount of an object to be displayed, or the like may be set as the information indicating the range of the open area. For example, when the open area is a space in voice, an output time of the voice may be set.

The price 405 is information indicating a charged amount for the policy input user 102 who uses the open area, and is set in step 304 in FIG. 3. For example, a fee per unit time such as per day may be set.

FIG. 5 is a diagram illustrating the open areas of various types set by virtual space information management system 1 according to the embodiment of the invention.

An open area 501 is a two-dimensional partial space having a pixel number of 1080 pixels×1920 pixels in the virtual space 100. The open area 501 corresponds to, for example, an area having an open area number “1” in the open area setting information 32 illustrated in FIG. 4.

An open area 502 is a three-dimensional partial space of 5 meters×3 meters×3 meters in the virtual space 100. The open area 502 corresponds to, for example, an area having an open area number “2” in the open area setting information 32 illustrated in FIG. 4.

An open area 503A is a partial space of 100 pixels×100 pixels in a UI screen 503B presented to the user. The open area 503A corresponds to, for example, an area having an open area number “3” in the open area setting information 32 illustrated in FIG. 4.

An open area 504 is voice for a predetermined period of time (for example, 60 seconds) when the user enters a specific room in the virtual space 100. The voice may include, for example, information for guiding the user. The open area 504 corresponds to, for example, an area having an open area number “4” in the open area setting information 32 illustrated in FIG. 4.

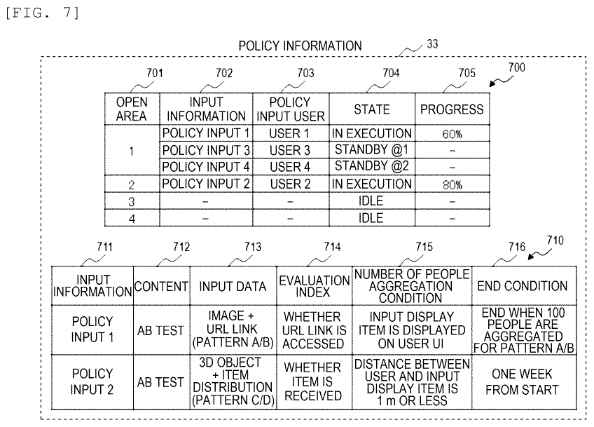

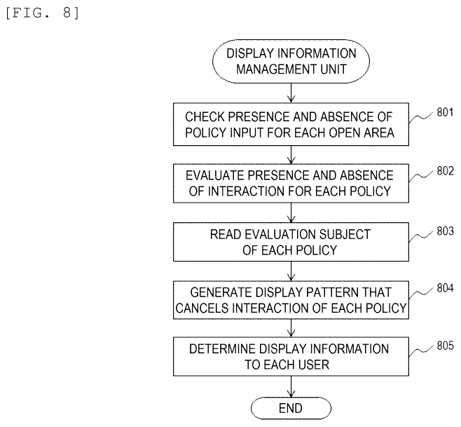

As described with reference to FIGS. 3 to 5, the virtual space manager 101 can set in advance one or more (a plurality of in the present embodiment) partial spaces in the virtual space 100 as the open areas. The policy input user 102 can input information regarding on a policy in the open area for performing the policy of his or her own. Processing when such an input is performed will be described with reference to FIGS. 6 and 7.

FIG. 6 is a flowchart illustrating processing executed by the input policy management unit 22 of the virtual space information management system 1 according to the embodiment of the invention.

The input policy management unit 22 receives an input from the policy input user 102 (step 601). This input may include, for example, information specifying a target open area, and information specifying a policy to be executed in the open area. In the present embodiment, as an example of the policy, a policy of testing and evaluating a reaction of a user when some action is performed on the space utilization user 103: is shown. A specific example of the policy is a so-called AB test in which a plurality of display items are shown to the space utilization user 103 and reactions of the user to the display items are compared.

Note that in the present embodiment, an example of a policy of displaying the display items has been described, but the invention can be applied to a policy of presenting any type of presentation item such as voice without being limited to the display item.

The input policy management unit 22 determines whether the policy can be registered based on the input information specifying the policy (step 602). Here, for example, it may be checked whether the data is suitable for display in the virtual space 100, such as whether the information to be displayed has copyright infringement or whether a violent content is included. The input policy management unit 22 may check whether the displayed information conforms to the regulation 404. When the displayed information violates the regulation, the input policy management unit 22 may stop the registration or may automatically change the information to conform to the regulation.

Next, the input policy management unit 22 checks the evaluation index of the input policy and the condition (step 603). For example, it may be checked whether the policy is actually executable in the virtual space 100. As the condition, an attribute (for example, gender and age group) of the space utilization user 103 to be evaluated may be designated. A limit may be set such as that the open area is used only in a specific time period.

Next, the input policy management unit 22 checks an operation of the input policy in the virtual space 100 (step 604). For example, the input policy management unit 22 may arrange a subject (for example, a two-dimensional image, a three-dimensional object, or a voice) defined by the input policy in the open area and check whether an expected operation is performed.

The above check of each stage may be automatically performed by the input policy management unit 22 based on a predetermined reference, or may be manually performed by the virtual space manager 101. As a result of the above processing, when it is checked that the evaluation of the policy can be executed in the virtual space 100, the input policy management unit 22 registers information on the input policy as the policy information 33 (step 605). In this case, settlement for the set fee may be performed. When it is determined that the evaluation of the policy cannot be executed, the input policy management unit 22 may request the policy input user 102 to re-input the information on the policy.

FIG. 7 is a diagram illustrating the policy information 33 held by the virtual space information management system 1 according to the embodiment of the invention.

The policy information 33 includes an input policy table 700 and a policy content table 710. The input policy table 700 holds information indicating correspondence with the open area of the registered policy input, an execution order, a current state, and the like. Specifically, the input policy table 700 includes an open area 701, input information 702, a policy input user 703, a state 704, and a progress 705.

The open area 701 is an identification number of the open area in which the input policy is performed, and corresponds to the open area number 401 in FIG. 4. The input information 702 is information for identifying an input policy. The policy input user 703 is information for identifying the policy input user 102 who inputs each policy. The state 704 and the progress 705 indicate the current state and the current progress of the policy allocated to each open area, respectively.

The policy content table 710 holds information on the content of the input policy. Specifically, the policy content table 710 includes input information 711, a content 712, input data 713, an evaluation index 714, a number of people aggregation condition 715, and an end condition 716.

The input information 711 is information for identifying an input policy, and corresponds to the input information 702 in the input policy table 700. The content 712 indicates the content of the input policy, for example, information such as what kind of policy the policy is. The input data 713 indicates data input as a policy. The evaluation index 714 indicates an evaluation index for a result of performing a policy. The number of people aggregation condition 715 indicates condition for aggregating the number of space utilization users 103 participated in the policy to evaluate result of performing the policy. The end condition 716 indicates a condition for ending execution of a policy.

Although omitted in the example of FIG. 7, the policy content table 710 may include information indicating an attribute of the space utilization user 103 to be evaluated in each policy.

In the example of the input policy table 700 illustrated in FIG. 7, three policy inputs of policy inputs “1”, “3”, and “4” are registered in the open area “1”.These three policies are input by policy input users “1”,“3”, and “4”, respectively. Among these, the state 704 of the policy input “1” is “in execution”, and the states 704 of the policy inputs “3” and “4” are “standby @1” and “standby @2”, respectively. The progress 705 of the policy input “1” is “60%”. It indicates that, in the open area “1”, the policy specified by the policy input “1” is currently executed and has progressed to 60%, and that the policies of the policy inputs “3” and “4” are scheduled to be sequentially executed after the policy ends.

On the other hand, referring to the example of the policy content table 710 illustrated in FIG. 7, the content 712 of the policy of the policy input “1” is an AB test, and the input data 713 is images of patterns “A” and “B” and uniform resource locator (URL) links. It indicates that the images of the patterns A and B and the URL links (which may be a two-dimensional barcode or the like) are displayed in the open area “1” (for example, a two-dimensional space as illustrated in FIG. 4) during the execution of the policy. Then, the evaluation index 714 is whether the URL link is accessed, and that the display item is displayed on the UI screen f the space utilization user 103, and the end condition is that the policy is ended when 100 people are aggregated for each of the patterns “A” and “B”.

In this case, the number of space utilization users 103 on whose screen the image of the pattern “A” is displayed and the number of space utilization users 103 on whose screen the image of the pattern “B” is displayed in the virtual space 100 are aggregated, and the execution of the policy ends when both the numbers reach 100. If the progress 705 is 60%, it indicates that 60 people have been aggregated at the current time.

Then, for each of the patterns “A” and “B”, a ratio of users who have accessed the link to the URL displayed together with the image among the space utilization users 103 on whose screen the image is displayed is calculated as an evaluation index, and the ratios for both are compared. For example, when the displayed image is an advertisement of a product or the like, it is possible to measure an effect, such as which advertisement pattern has a larger influence on the user.

Although an example in which a two-dimensional image is displayed in a two-dimensional open area has been described in the above example, the input data 713 may be a three-dimensional object displayed in a three-dimensional open area, or some kind of item distributed together. In this case, for example, a plurality of patterns of objects may be prepared as objects to be displayed, or a plurality of patterns of items may be prepared as items to be distributed. When an item is distributed, the evaluation index 714 may be whether the space utilization user has received the item. The number of people aggregation condition 715 may be that a distance to the display item is a predetermined value (for example, 1 meter) or less. The end condition 716 may be that a predetermined period of time (for example, one week) has elapsed from the start of execution of the policy.

In the case where the policy input is a display on the UI screen or a UI voice, the content 712, the input data 713, the evaluation index 714, the number of people aggregation condition 715, and the end condition 716 are similarly defined.

Next, display of policies based on the policy information 33 will be described. For example, when the space utilization user 103 enters the virtual space 100 or comes to a space near the open area in the virtual space, the display information management unit 23 may determine a display item to be displayed to the space utilization user 103 in the open area. For example, when an AB test is performed as a policy, different information may be presented for each user in one open area. In this case, the display information management unit 23 manages and controls presentation information to the user SO that a plurality of policies can be simultaneously executed in a plurality of open areas in one virtual space 100. Whether a plurality of policies can be executed simultaneously is determined based on, for example, whether an interaction occurs among the policies. The display information management unit 23 may present another policy content to the user who has been subjected to policy evaluation once. The display information management unit 23 does not display the policy satisfying the end condition.

Hereinafter, specific processing of the display information management unit 23 will be described with reference to FIGS. 8 to 10.

FIG. 8 is a flowchart illustrating the processing executed by the display information management unit 23 of the virtual space information management system 1 according to the embodiment of the invention.

The display information management unit 23 refers to the policy information 33 and checks whether there is a policy input for each open area (step 801). Next, when there are a plurality of policy inputs for a plurality of open areas in one virtual space 100 based on the policy information 33, the display information management unit 23 evaluates presence and absence of an interaction of each policy (step 802).

For example, when a distance between the display items (that is, a distance between the open areas is shorter than a predetermined reference, it may be evaluated that there may be an interaction. Alternatively, when a plurality of display items are simultaneously displayed on the screen of the space utilization user 103, it may be evaluated that there may be an interaction. Alternatively, it may be evaluated that there may be an interaction in a case where similar policies are executed in adjacent open areas based on a degree of relevance between the displayed contents or the like.

Next, the display information management unit 23 reads an evaluation subject of each policy (step 803). Then, when there is an interaction of each policy, the display information management unit 23 generates a display pattern that cancels the interaction (step 804), and determines display information for each space utilization user 103 based on the pattern (step 805).

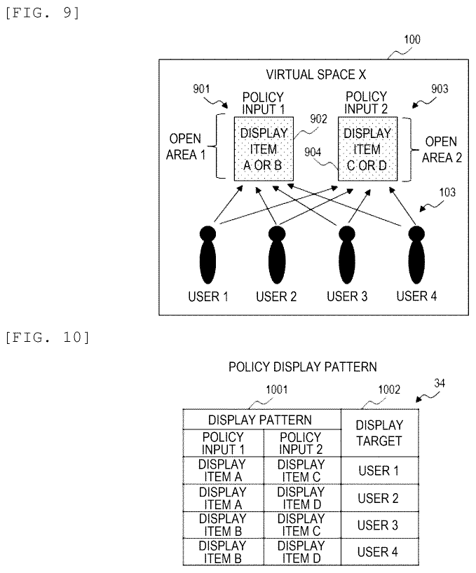

The pattern that cancels the interaction is a display pattern of each display item in which influence of one display item can be evaluated without being affected by the other display item, and an example thereof will be described later with reference to FIG. 9 and the like. When it is evaluated that the interaction cannot be completely eliminated when the display items are simultaneously displayed, the display information management unit 23 may stop the display of one open area.

FIG. 9 is a diagram illustrating generation of the display pattern by the display information management unit 23 of the virtual space information management system 1 according to the embodiment of the invention.

In the example of FIG. 9, two types of display items 902 of patterns “A” and “B” are displayed in an open area 901 in the virtual space 100 based on a first policy input. On the other hand, two types of display items 904 of patterns “C” and “D” are displayed in another open area 903 in the same virtual space 100 based on a second policy input. Each display item may be, for example, a two-dimensional image or a three-dimensional object. Hereinafter, the open area 901 and the open area 903 are also referred to as an open area 1 and an open area 2, respectively. The first policy input and the second policy input are also referred to as a policy input 1 and a policy input 2, respectively. The display item of the pattern “A” to the display item of the pattern “D” are also referred to as a display item A to a display item D, respectively. A first space utilization user 103 to a fourth space utilization user 103 are also referred to as a user 1 to a user 4, respectively.

For example, in a case where it is specified that the display item 902 is displayed in the open area 901 of the virtual space 100 and the display item 904 is displayed in the open area 903 in step 801 of FIG. 8, and it is evaluated that there is an interaction between these display items in step 802, a display pattern that cancels the interaction is generated and held as the policy display pattern 34 in step 804.

The plurality of types of display items such as the patterns “A” and “B” and the patterns “C” and “D” are switched according to the space utilization user 103. For example, the display information management unit 23 may display the display item A and the display item C for the user 1, the display item A and the display item D for the user 2, the display item B and the display item C for the user 3, and the display item B and the display item B for the user 4.

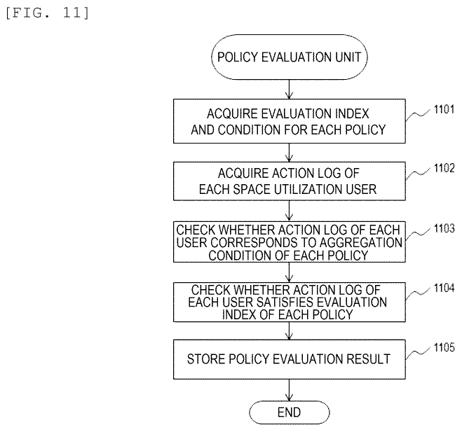

FIG. 10 is a diagram illustrating the policy display pattern 34 held by the virtual space information management system 1 according to the embodiment of the invention.

The policy display pattern 34 includes a display pattern 1001 and a display target 1002. In the display pattern 1001, all (that is, four) combinations of the display item A and the display item B displayed based on the policy input 1 and the display item C and the display item D displayed based on the policy input 2 are registered. In the display target 1002, the space utilization users 103 as the display target of each combination are registered.

In the example of FIG. 10, as described with reference to FIG. 9, control is performed such that the display item A and the display item C are displayed for the user 1, the display item A and the display item D are displayed for the user 2, the display item B and the display item C are displayed for the user 3, and the display item B and the display item D are displayed for the user 4.

For example, a case is assumed in which there is a relevance between the policy input 1 and the policy input 2, and there is an interaction such as that a user who sees the display item C with respect to the policy input 2 is more likely to be affected by the display item A than the display item B with respect to the policy input 1, and a user who sees the display item D is more likely to be affected by the display item B than the display item A. In this case, if it is evaluated that the number of users affected by the display item A is larger than the number of users affected by the display item B as a result of the AB test based on the policy, it cannot be determined whether the result is caused only by the difference between the display item A and the display item B or is a reflection of the influence from the display item C and the display item D.

However, in the example of FIG. 10, the user 1 and the user 2 who have seen the display item A are seeing the display item C and the display item D, respectively. On the other hand, the user 3 and the user 4 who have seen the display item B are similarly seeing the display item C and the display item D, respectively. That is, among the users to whom the display item A is displayed, the user to whom the display item C is displayed and the user to whom the display item D is displayed become even, and among the users to whom the display item B is displayed, the user to whom the display item C is displayed and the user to whom the display item D is displayed become even. Therefore, when comparing the influence on the user 1 to the user 4 received from the display item A and the display item B, even if there is an interaction between the policy input 1 and the policy input 2, the interaction is canceled, and the influence from the display item A and the influence from the display item B can be compared.

Next, policy evaluation by the policy evaluation unit 24 will be described. The policy evaluation unit 24 evaluates the policy based on an action log of the space utilization user 103 in the virtual space 100. Here, the action log is, for example, action information of the user stored in time series, and may include information of coordinates for each time, and information of actions such as walking, running, touching an object, and operating a UI.

The policy evaluation is performed based on whether the space utilization user 103 visits a policy execution area and performs a designated action (for example, access to a displayed URL). Here, the designated action may adopt three or more patterns instead of binary determination such as access and no access.

The evaluation may be sequentially executed, and the policy evaluation unit 24 may send policy end information to the input policy management unit 22 when the end condition of the policy is satisfied.

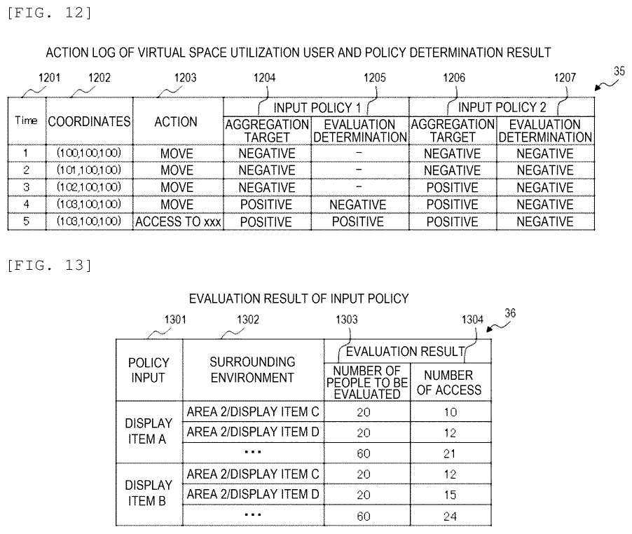

Hereinafter, details of the policy evaluation by the policy evaluation unit 24 will be described with reference to FIGS. 11 to 13.

FIG. 11 is a flowchart illustrating processing executed by the policy evaluation unit 24 of the virtual space information management system 1 according to the embodiment of the invention.

The policy evaluation unit 24 acquires the evaluation index 714 and the number of people aggregation condition 715 of each policy (step 1101). Next, the policy evaluation unit 24 acquires the action log of each space utilization user 103 (step 1102). Next, the policy evaluation unit 24 checks whether the action log of each space utilization user 103 corresponds to the number of people aggregation condition 715 of each policy (step 1103).

Next, the policy evaluation unit 24 checks whether the action log of each space utilization user 103 corresponds to the number of people aggregation condition 715 of each policy (step 1103). Next, the policy evaluation unit 24 checks whether the action log of each space utilization user 103 satisfies the evaluation index 714 of each policy (step 1104). These results are stored as the policy determination result 35 with the action log of the virtual space utilization user.

Note that the policy evaluation unit 24 may give a predetermined point (for example, a coupon or the like that can be used to purchase a product or the like) to the space utilization user 103 whose action log is determined to correspond to the number of people aggregation condition 715 of each policy. Accordingly, it is possible to increase the number of participants in the policy.

Then, the policy evaluation unit 24 generates a policy evaluation result based on the results of step 1103 and step 1104 and stores the policy evaluation result as the input policy evaluation result 36 (step 1105).

FIG. 12 is a diagram illustrating an action log of the virtual space utilization user held by the virtual space information management system 1 and the policy determination result 35 according to the embodiment of the invention.

The action log of the virtual space utilization user and the policy determination result 35 include a time 1201, coordinates 1202, an action 1203, an aggregation target 1204 of the input policy 1, an evaluation determination 1205 of the input policy 1, an aggregation target 1206 of the input policy 2, and an evaluation determination 1207 of the input policy 2.

Here, as an example, an action log of one space utilization user 103 and a policy determination result based on the action log are shown. The time 1201 to the action 1203 correspond to an action log of the user. Based on these pieces of information, a position of the user at each time and an action performed at the position are specified. By collating these pieces of information with the number of people aggregation condition 715 and the evaluation index 714, it is determined whether the user is an aggregation target of each input policy and whether the user satisfies the evaluation index at each time.

In the example of FIG. 10, the user moves in the virtual space 100 from a time 1 to a time 4, and access to, for example, information corresponding to the policy input 1 (for example, access to a URL included in the display item displayed by the policy input 1) at the time 5. In this example, the user is an aggregation target of the input policy 2 after the time 3, is an aggregation target of the input policy 1 after the time 4, and satisfies the evaluation index of the input policy at the time 5.

The same evaluation is performed for each user, and it is determined whether each user is an aggregation target of each policy input and whether each user satisfies the evaluation index of each policy input.

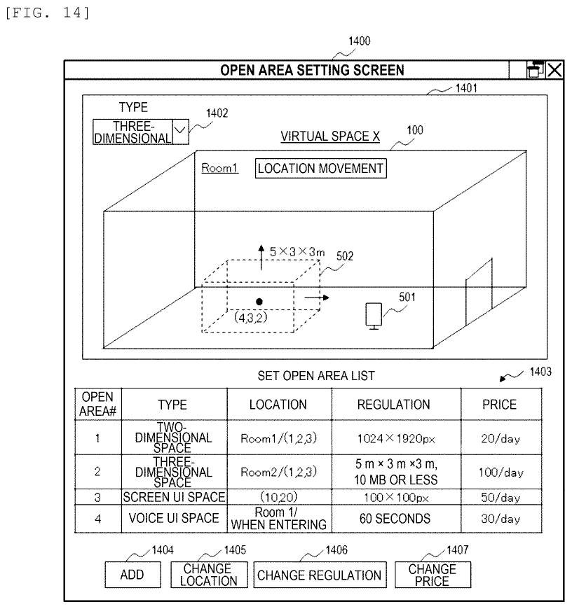

FIG. 13 is a diagram illustrating the evaluation result 36 of the input policy held by the virtual space information management system 1 according to the embodiment of the invention.

The evaluation result 36 of the input policy includes a policy input 1301, a surrounding environment 1302, the number of people to be evaluated 1303 as the evaluation result, and the number of access 1304 as the evaluation result. The policy input 1301 is information specifying a display item in a certain policy. The surrounding environment 1302 indicates a surrounding environment of an area in which the policy is performed, specifically, policies performed in the surroundings, display items therein, and the like. The number of people to be evaluated 1303 as the evaluation result indicates the number of space utilization users 103 determined to correspond to the number of people aggregation condition 715 of the policy in step 1103. The number of access 1304 as the evaluation result indicates the number of space utilization users 103 whose action log is determined to satisfy the evaluation index 714 of the policy in step 1104.

FIG. 13 illustrates an example of the evaluation result of the input policy in the open area 1 illustrated in FIG. 9. In this example, it is shown that among the space utilization users 103 to whom the display item A is presented in the open area 1 and who become the evaluation subjects, the number of users to whom the display item C has been presented in the open area 2 near the open area 1 was 20, and among these, the number of users who satisfy the evaluation index (for example, access the displayed URL) was 10. Similarly, among the space utilization users 103 to whom the display item A is presented in the open area 1 and who become the evaluation subjects, the number of users to whom the display item D has been presented in the open area 2 near the open area 1 was 20, and among these, the number of users who satisfy the evaluation index was 12.

Among the space utilization users 103 to whom the display item B is presented in the open area 1 and who become the evaluation subjects, the number of users to whom the display item C has been presented in the open area 2 near the open area 1 was 20, and among these, the number of users who satisfy the evaluation index was 12. Among the space utilization users 103 to whom the display item B is presented in the open area 1 and who become the evaluation subjects, the number of users to whom the display item D has been presented in the open area 2 near the open area 1 was 20, and among these, the number of users who satisfy the evaluation index was 15.

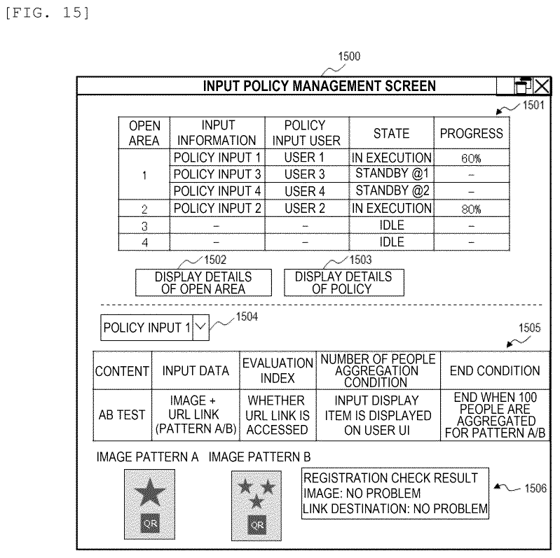

Next, display screens output by the virtual space information management system 1 will be described with reference to FIGS. 14 to 16. These display screens may be displayed by the output device 13, or may be output by a terminal device (not illustrated) or the like used by the virtual space manager 101 via the network 4.

FIG. 14 is a diagram illustrating an open area setting screen output by the virtual space information management system 1 according to the embodiment of the invention.

An open area setting screen 1400 illustrated in FIG. 14 is displayed by the output device 13 when the processing of the open area setting unit 21 illustrated in FIG. 3 is executed. Specifically, the open area setting screen 1400 includes a virtual space display portion 1401, an area type selection portion 1402, a set open area list display portion 1403, an add button 1404, a location change button 1405, a regulation change button 1406, and a price change button 1407. When the virtual space manager 101 operates the open area setting screen 1400 using the input device 12, the processing of the open area setting unit 21 is executed.

In the virtual space display portion 1401, for example, a diagram illustrating the entire virtual space 100 is displayed. In the example of FIG. 14, an oblique projection diagram of the virtual space 100 is displayed. In the area type selection portion 1402, for example, a pull-down menu of selectable types of open areas is displayed, and any one of the types can be selected by an operation of the virtual space manager 101.

For example, the virtual space manager 101 can set the location and size (regulation) of the three-dimensional open area 502 by selecting a three-dimensional space in the area type selection portion 1402 and operating a cursor (not illustrated) in the virtual space display portion 1401. An already set open area (for example, the open area 501) may be displayed in the virtual space display portion 1401.

Information on the set open area is displayed in the set open area list display portion 1403. In the example of FIG. 14, information similar to that illustrated in FIG. 4 is displayed. The virtual space manager 101 can add a new open area by operating the add button 1404. By operating the location change button 1405, the regulation change button 1406, and the price change button 1407, the location, the regulation, and the price of the set open area can be changed.

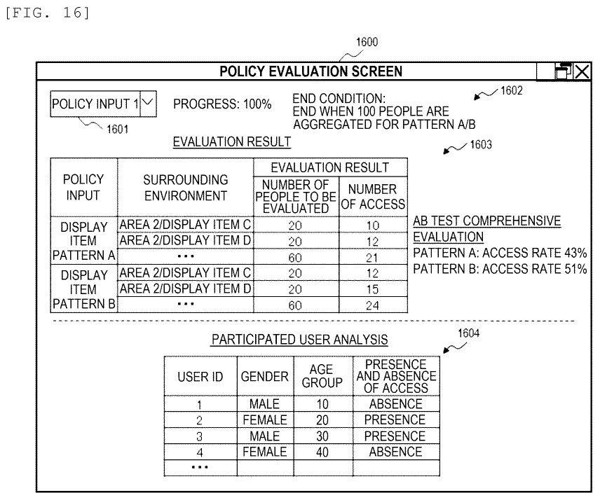

FIG. 15 is a diagram illustrating an input policy management screen output by the virtual space information management system 1 according to the embodiment of the invention.

An input policy management screen 1500 illustrated in FIG. 15 is displayed by the output device 13 when the processing of the input policy management unit 22 illustrated in FIG. 6 is executed and when the input policy set as a result thereof is executed. Specifically, the input policy management screen 1500 includes an input policy list display portion 1501, an open area detail display button 1502, a policy detail display button 1503, a policy selection portion 1504, a policy detail display portion 1505, and a check result display portion 1506.

In the input policy list display portion 1501, a list of input policies is displayed. In the example of FIG. 15, information similar to the input policy table 700 illustrated in FIG. 7 is displayed. When the virtual space manager 101 operates the open area detail display button 1502, information indicating details of each open area is displayed, and when the virtual space manager 101 operates the policy detail display button 1503, information indicating details of the input policy is displayed.

When the virtual space manager 101 operates the policy detail display button 1503, for example, the policy selection portion 1504, the policy detail display portion 1505, and the check result display portion 1506 may be displayed. When the virtual space manager 101 operates the policy selection portion 1504 to select a policy, information indicating details of the policy is displayed on the policy detail display portion 1505. In the example of FIG. 15, the policy input 1 is selected in the policy selection portion 1504, and information on the policy input 1 in the policy content table 710 illustrated in FIG. 5 is displayed in the policy detail display portion 1505.

In the check result display portion 1506, a check result of the selected policy is displayed. For example, when the content of the selected policy is an AB test and images of two patterns of A and B are displayed in the policy, the images of the two patterns and check results thereof may be displayed.

FIG. 16 is a diagram illustrating a policy evaluation screen output by the virtual space information management system 1 according to the embodiment of the invention.

A policy evaluation screen 1600 illustrated in FIG. 16 is a screen for displaying the policy evaluation result obtained by the processing of the policy evaluation unit 24 illustrated in FIG. 11. Specifically, the policy evaluation screen 1600 includes a policy selection portion 1601, a state display portion 1602, an evaluation result display portion 1603, and a participating user analysis result display portion 1604. Note that this: screen may be displayed to the virtual space manager 101 by the output device 13, or may be displayed to the policy input user 102 via the network 4. Here, a case where the policy evaluation screen 1600 is displayed to the virtual space manager 101 will be described as an example.

When the virtual space manager 101 operates the policy selection portion 1601 to select any one of the policies, the current state of the selected policy is displayed in the state display portion 1602, the evaluation result of the selected policy is displayed in the evaluation result display portion 1603, and a result of analyzing the space utilization user 103 participated in the selected policy is displayed in the participating user analysis result display portion 1604.

For example, the current progress rate and the end condition of the selected policy are displayed in the state display portion 1602. In the evaluation result display portion 1603, for example, the content of the input policy evaluation result 36 illustrated in FIG. 13 may be displayed as the evaluation result. In the participating user analysis result display portion 1604, attributes (for example, gender, age group, and the like) of each space utilization user 103 who participated in the selected policy (that is, who satisfies the number of people aggregation condition 715 of the policy) and whether the evaluation index 714 is satisfied (for example, whether the displayed URL is accessed) may be displayed.

The system according to the embodiment of the invention may have the following configurations.
(1) A virtual space information management method executable by a computer system (for example, virtual space information management system 1), the computer system including a control device (for example, central control device 11) that executes predetermined processing and a storage device (for example, at least one of main storage device 15 and auxiliary storage device 16) accessible by the control device, the storage device holding virtual space configuration information (for example, virtual space configuration information 31) indicating a configuration of a virtual space, the virtual space information management method including:
an area setting procedure (for example, processing of open area setting unit 21, FIG. 3 and the like) of, by the control device, when receiving an input of information on setting a partial space in the virtual space, holding the information on setting the partial space (for example, open areas 501 to 504 and the like) in the storage device as area setting information;
an input policy management procedure (for example, processing of input policy management unit 22, FIG. 6 and the like) of, by the control device, when receiving an input of information on a policy executed in the partial space, holding the information on the policy in the storage device as policy information;
an output information management procedure (for example, processing of display information management unit 23, FIG. 8 and the like) of, by the control device, generating information to be output to a user (for example, space utilization user 103) of the virtual space and holding the information in the storage device as policy display pattern information based on the policy in the partial space; and
a policy evaluation procedure (for example, processing of policy evaluation unit 24, FIG. 11 and the like) of, by the control device, evaluating the policy based on an action of the user of the virtual space in the virtual space.

Accordingly, it is possible to appropriately manage the policies executed in the virtual space and to achieve efficient and highly accurate policy evaluation.
(2) The virtual space information management method according to the above (1), in which
in the area setting procedure, the control device sets a plurality of the partial spaces,
in the input policy management procedure, the control device stores, as the policy information, information on a plurality of the policies executed in the plurality of partial spaces,
the policy executed in each f the plurality of partial spaces is a comparison test (for example, AB test) of outputting a plurality of presentation items (for example, may be display items or voice) in the partial spaces, and
in the output information management procedure, the control device generates the information to be output to the user of the virtual space such that any one of the plurality of presentation items is output to each of a plurality of users of the virtual space in each of the partial spaces (for example, steps 804, 805).

Accordingly, it is possible to execute a plurality of policies in one virtual space and achieve efficient policy evaluation.
(3) The virtual space information management method according to the above (2), in which
in the output information management procedure, the control device
   evaluates presence and absence of an interaction among the plurality of policies (for example, step 802), and
   generates, when evaluating that there is an interaction among the plurality of policies, information to be output to each of the plurality of users of the virtual space to cancel the interaction for each of the plurality of policies (for example, steps 804, 805).

Accordingly, it is possible to achieve highly accurate policy evaluation even when a plurality of policies are executed in one virtual space.
(4) The virtual space information management method according to the above (3), in which
the plurality of partial spaces include a first partial space and a second partial space,
the plurality of policies include a first policy (for example, policy input 1) executed in the first partial space (for example, open area1 in FIG. 9) and a second policy (for example, policy input 2) executed in the second partial space (for example, open area 2),
the first policy is a comparison test of outputting a first presentation item (for example, display item A) or a second presentation item (for example, display item B) in the first partial space,
the second policy is a comparison test outputting a third presentation item (for example, display item C) or a fourth presentation item (for example, display item D) in the second partial space, and
in the output information management procedure, the control device generates the information to be output to each of the plurality of users of the virtual space in each of the partial spaces such that, among the plurality of users of the virtual space, users to whom the first presentation item is output in the first partial space include evenly a user to whom the third presentation item is output and a user to whom the fourth presentation item is output in the second partial space, and users to whom the second presentation item is output in the first partial space include evenly a user to whom the third presentation item is output and a user to whom the fourth presentation item is output in the second partial space.

Accordingly, it is possible to achieve highly accurate policy evaluation even when a plurality of policies are executed in one virtual space.
(5) The virtual space information management method according to the above (4), in which
each of the first partial space and the second partial space is a two-dimensional or three-dimensional partial space in the virtual space (for example, open area 501 or 502),
each of the first presentation item, the second presentation item, the third presentation item, and the fourth presentation item is an image displayed in the two-dimensional partial space or a three-dimensional object displayed in the three-dimensional partial space, and
in the output information management procedure, the control device evaluates the presence and absence of the interaction among the plurality of policies based on at least one of a distance between the first partial space and the second partial space, whether the presentation item displayed in the first partial space and the presentation item displayed in the second partial space are simultaneously displayed on a screen of the user of the virtual space, and relevance between the presentation item displayed in the first partial space and the presentation item displayed in the second partial space (for example, step 802).

Accordingly, it is possible to appropriately evaluate the interaction when a plurality of policies are executed in one virtual space and achieve highly accurate policy evaluation.
(6) The virtual space information management method according to the above (2), in which
each of the plurality of partial spaces is any one of a two-dimensional partial space in the virtual space, a three-dimensional partial space in the virtual space, a partial space in a screen referred to by the user of the virtual space, and a partial space in voice output to the user of the virtual space (for example, open areas 501 to 504),
the information on the plurality of policies includes, as information on the presentation items, any one of information on an image displayed in the two-dimensional partial space in the virtual space, information on a three-dimensional object displayed in the three-dimensional partial space in the virtual space, information displayed in the partial space in the screen referred to by the user of the virtual space, and information output as voice to the user of the virtual space, and
the information on the plurality of policies is input by different inputters (for example, policy input user 102).

Accordingly, it is possible to achieve various policy evaluations with a high degree of freedom according to needs of various users.
(7) The virtual space information management method according to the above (2), in which
the information on the plurality of policies includes information on the presentation items, a data aggregation condition in the comparison test, an evaluation item, and an end condition (for example, FIG. 7).

Accordingly, it is possible to appropriately manage the policy evaluation.
(8) The virtual space information management method according to the above (7), in which
when the policy information includes information on a plurality of policies executed in the same partial space, the policy information includes information indicating an execution order of the plurality of policies (for example, input information 702), and
in the policy evaluation procedure, the control device executes and evaluates the plurality of policies in order based on the information indicating the execution order.

Accordingly, it is possible to appropriately manage the policy evaluation.
(9) The virtual space information management method according to the above (7), in which
the data aggregation condition includes a condition for aggregating the users of the virtual space participated in each of the plurality of policies (for example, number of people aggregation condition 715),
the evaluation item includes information indicating an action of the user of the virtual space serving as a criterion for evaluation for each of the plurality of policies (for example, evaluation index 714), and
in the policy evaluation procedure, the control device aggregates the number of users participated in the policy and the number of users performed the action serving as the criterion for evaluation among the plurality of users of the virtual space based on an action log of the plurality of users of the virtual space, and outputs an evaluation result based on the aggregated number of the users.

Accordingly, the policy is appropriately evaluated.
(10) The virtual space information management method according to the above (9), in which
the condition for aggregating the participated users of the virtual space is a condition based on a distance between the partial space in the virtual space and the user of the virtual space or whether the partial space is displayed on a screen of the user of the virtual space,
the action of the user of the virtual space serving as the criterion for evaluation is access to predetermined information (for example, access to displayed URL) or reception of predetermined information (for example, reception of item), and
the end condition is defined based on an elapsed time from execution of the policy or the number of users of the virtual space participated in the policy.

Accordingly, the policy is appropriately evaluated.
(11) The virtual space information management method according to the above (9), in which
the condition for aggregating the participated users of the virtual space includes information indicating an attribute of the user of the virtual space to be aggregated.

Accordingly, the policy is appropriately evaluated.
(12) The virtual space information management method according to the above (9), in which
in the policy evaluation procedure, the control device gives a predetermined point to the user of the virtual space participated in the policy.

Accordingly, it is possible to increase the number of participants in the evaluation of the policy and achieve highly accurate evaluation.
(13) The virtual space information management method according to the above (2), in which
the area setting information includes, for each of the plurality of partial spaces, information on a position and a size of the partial space, and a standard (regulation) and a utilization price of the presentation item (for example, FIG. 4).

Accordingly, the partial space in which the policy is executed is appropriately managed.
(14) The virtual space information management method according to the above (12), in which
in the input policy management procedure, the control device determines whether the notice included in the information on the input policy satisfies a standard of the notice included in the area setting information, and
when the notice does not satisfy the standard, the control device does not hold the information on the input policy as the policy information or corrects the information on the input policy the notice satisfies the standard (for example, step 603).

Accordingly, the presentation item in the policy is appropriately managed.

The invention is not limited to the embodiment described above, and includes various modifications. For example, the above-described embodiment is described in detail for a better understanding of the invention, and the invention is not necessarily limited to those including all the configurations described above. A part of a configuration according to one embodiment can be replaced with a configuration according to another embodiment, and a configuration according to one embodiment can also be added to a configuration according to another embodiment. A part of a configuration in each embodiment may be added to, deleted from, or replaced with another configuration.
A part or all of configurations, functions, processing units, processing methods, and the like described above may be implemented by hardware by, for example, designing with an integrated circuit. In addition, the configurations, functions, and the like described above may be implemented by software by a processor interpreting and executing a program for implementing each function. Information such as a program, a table, and a file for implementing each function can be stored in a storage device such as a nonvolatile semiconductor memory, a hard disk drive, and a solid state drive (SSD), or a computer-readable non-transitory data storage medium such as an IC card, an SD card, and a DVD.

Control lines and information lines indicate what is considered to be necessary for explanation, and not necessarily all control lines and information lines are always shown on a product. Actually, almost all configurations may be considered to be connected.

1. A virtual space information management method executable by a computer system, the computer system including a control device that executes predetermined processing and a storage device accessible by the control device, the storage device holding virtual space configuration information indicating a configuration of a virtual space, the virtual space information management method comprising:
an area setting procedure of, by the control device, when receiving an input of information on setting a partial space in the virtual space, holding the information on setting the partial space in the storage device as area setting information;
an input policy management procedure of, by the control device, when receiving an input of information on a policy executed in the partial space, holding the information on the policy in the storage device as policy information;
an output information management procedure of, by the control device, generating information to be output to a user of the virtual space and holding the information in the storage device as policy display pattern information based on the policy in the partial space; and
a policy evaluation procedure of, by the control device, evaluating the policy based on an action of the user of the virtual space in the virtual space.

2. The virtual space information management method according to claim 1, wherein
in the area setting procedure, the control device sets a plurality of the partial spaces,
in the input policy management procedure, the control device stores, as the policy information, information on a plurality of the policies executed in the plurality of partial spaces,
the policy executed in each of the plurality of partial spaces is a comparison test of outputting a plurality of presentation items in the partial spaces, and
in the output information management procedure, the control device generates the information to be output to the user of the virtual space such that any one of the plurality of presentation items is output to each of a plurality of users of the virtual space in each of the partial spaces.

3. The virtual space information management method according to claim 2, wherein
in the output information management procedure, the control device
evaluates presence and absence of an interaction among the plurality of policies, and
generates, when evaluating that there is an interaction among the plurality of policies, information to be output to each of the plurality of users of the virtual space to cancel the interaction for each of the plurality of policies.

4. The virtual space information management method according to claim 3, wherein
the plurality of partial spaces include a first partial space and a second partial space,
the plurality of policies include a first policy executed in the first partial space and a second policy executed in the second partial space,
the first policy is a comparison test of outputting a first presentation item or a second presentation item in the first partial space,
the second policy is a comparison test of outputting a third presentation item or a fourth presentation item in the second partial space, and
in the output information management procedure, the control device generates the information to be output to each of the plurality of users of the virtual space in each of the partial spaces such that, among the plurality of users of 41 the virtual space, users to whom the first presentation item is output in the first partial space include evenly a user to whom the third presentation item is output and a user to whom the fourth presentation item is output in the second partial space, and users to whom the second presentation item is output in the first partial space include evenly a user to whom the third presentation item is output and a user to whom the fourth presentation item is output in the second partial space.

5. The virtual space information management method according to claim 4, wherein
each of the first partial space and the second partial space is a two-dimensional or three-dimensional partial space in the virtual space,
each Of the first presentation item, the second presentation item, the third presentation item, and the fourth presentation item is an image displayed in the two-dimensional partial space or a three-dimensional object displayed in the three-dimensional partial space, and
in the output information management procedure, the control device evaluates the presence and absence of the interaction among the plurality of policies based on at least one of a distance between the first partial space and the second partial space, whether the presentation item displayed in the first partial space and the presentation item displayed in the second partial space are simultaneously displayed on a screen of the user of the virtual space, and relevance between the presentation item displayed in the first partial space and the presentation item displayed in the second partial space.

6. The virtual space information management method according to claim 2, wherein
each of the plurality of partial spaces is any one of a two-dimensional partial space in the virtual space, a three-dimensional partial space in the virtual space, a partial space in a screen referred to by the user of the virtual space, and a partial space in voice output to the user of the virtual space,
the information on the plurality of policies includes, as information on the presentation items, any one of information on an image displayed in the two-dimensional partial space in the virtual space, information on a three-dimensional object displayed in the three-dimensional partial space in the virtual space, information displayed in the partial space in the screen referred to by the user of the virtual space, and information output as voice to the user of the virtual space, and
the information on the plurality of policies is input by different inputters.

7. The virtual space information management method according to claim 2, wherein
the information on the plurality of policies includes information on the presentation items, a data aggregation condition in the comparison test, an evaluation item, and an end condition.

8. The virtual space information management method according to claim 7, wherein
when the policy information includes information on a plurality of policies executed in the same partial space, the policy information includes information indicating an execution order of the plurality of policies, and
in the policy evaluation procedure, the control device executes and evaluates the plurality of policies in order based on the information indicating the execution order.

9. The virtual space information management method according to claim 7, wherein
the data aggregation condition includes a condition for aggregating the users of the virtual space participated in each of the plurality of policies,
the evaluation item includes information indicating an action of the user of the virtual space serving as a criterion for evaluation for each of the plurality of policies, and
in the policy evaluation procedure, the control device aggregates the number of users participated in the policy and the number of users performed the action serving as the criterion for evaluation among the plurality of users of the virtual space based on an action log of the plurality of users of the virtual space, and outputs an evaluation result based on the aggregated number of the users.

10. The virtual space information management method according to claim 9, wherein
the condition for aggregating the participated users of the virtual space is a condition based on a distance between the partial space in the virtual space and the user of the virtual space or whether the partial space is displayed on a screen of the user of the virtual space,
the action of the user of the virtual space serving as the criterion for evaluation is access to predetermined information or reception of predetermined information, and
the end condition is defined based on an elapsed time from execution of the policy or the number of users of the virtual space participated in the policy.

11. The virtual space information management method according to claim 9, wherein
the condition for aggregating the participated users of the virtual space includes information indicating an attribute of the user of the virtual space to be aggregated.

12. The virtual space information management method according to claim 9, wherein
in the policy evaluation procedure, the control device gives a predetermined point to the user of the virtual space participated in the policy.

13. The virtual space information management method according to claim 2, wherein
the area setting information includes, for each of the plurality of partial spaces, information on a position and a size of the partial space, and a standard and a utilization price of the presentation item.

14. The virtual space information management method according to claim 12, wherein
in the input policy management procedure, the control device determines whether the notice included in the information on the input policy satisfies a standard of the notice included in the area setting information, and
when the notice does not satisfy the standard, the control device does not hold the information on the input policy as the policy information or corrects the information on the input policy such that the notice satisfies the standard.

15. A virtual space information management system, comprising:
a control device that executes predetermined processing; and
a storage device accessible by the control device, wherein
the storage device is configured to hold virtual space configuration information indicating a configuration of a virtual space, and
the control device is configured to
when receiving an input of information on setting a partial space in the virtual space, hold the information on setting the partial space in the storage device as area setting information;
when receiving an input of information on a policy executed in the partial space, hold the information on the policy in the storage device as policy information;
generate information to be output to a user of the virtual space and hold the information in the storage device as policy display pattern information based on the policy in the partial space, and
evaluate the policy based on an action of the user of the virtual space in the virtual space.
